(19) United States
(12) Patent Application Publication
(10) Pub. No.: US 2015/0078358 A1
(43) Pub. Date: Mar. 19, 2015

(54) METHOD AND APPARATUS FOR SETTING UP HIGH-SPEED LINK IN WLAN SYSTEM

(71) Applicant: LG ELECTRONICS INC., Seoul (KR)

(72) Inventors: Giwon Park, Anyang-si (KR); Jaehyung Song, Anyang-si (KR); Jinsam Kwak, Anyang-si (KR); Kiseon Ryu, Anyang-si (KR)

(73) Assignee: LG ELECTRONICS INC., Seoul (KR)

(21) Appl. No.: 14/378,906

(22) PCT Filed: Feb. 14, 2013
(86) PCT No.: PCT/KR2013/001147

§ 371 Date: Aug. 14, 2014

Related U.S. Application Data
(60) Provisional application No. 61/598,344, filed on Feb. 14, 2012.
(60) Provisional application No. 61/602,591, filed on Feb. 24, 2012.
(60) Provisional application No. 61/637,283, filed on Apr. 24, 2012.

(51) Int. Cl. H04W 48/14

(52) U.S. Cl. CPC H04W 48/14; H04W 84/12
USPC 370/338

(57) ABSTRACT

The present invention relates to a wireless communication system, and more specifically, disclosed are a method and an apparatus for setting up a high-speed link in a WLAN system. A method for a station (STA) setting up the high-speed link in a wireless communication system, according to one embodiment of the present invention, comprises the steps of: transmitting to an access point (AP) a request frame including a generic advertisement service (GAS) configuration change query; and receiving from the AP a response frame including response information with respect to the GAS configuration change query, wherein the response information may include GAS step skipping information when AS information saved in the STA matches the GAS information saved in the AP.

### TECHNICAL FIELD

The following descriptions relate to a wireless communication system and, more specifically, to a method and apparatus for transmitting/receiving neighboring network information.

### BACKGROUND ART

With the growth of information communication technology, various wireless communication technologies are under development. Among the wireless communication technologies, wireless local area network (WLAN) technology enables wireless Internet access at home or in offices or specific service provision areas using a mobile terminal such as a personal digital assistant (PDA), laptop computer, portable multimedia player (PMP) or the like on the basis of radio frequency technology.

To overcome the limitations of communication rate, which have been cited as a weak point of WLAN, recent technical standards have introduced systems with increased network rate and reliability and extended wireless network coverage. For example, IEEE 802.11n supports high throughput (HT) of a data rate of 540 Mbps or higher and introduces MIMO (Multiple Input Multiple Output) technology which uses multiple antennas for both a transmitter and a receiver in order to minimize a transmission error and optimize a data rate.

IEEE 802.11ai is developed as a new standard for supporting fast initial link setup for stations (STAs) that support IEEE 802.11 at a MAC (Medium Access Control) layer of IEEE 802.11 systems. IEEE 802.11ai aims to provide technologies for supporting high-speed link setup in a situation in which so many people leave previously connected WLAN coverage and substantially simultaneously access a new WLAN in the case of public transportation transfer, for example. In addition, IEEE 802.11ai has characteristics of security framework, IP address assignment, fast network discovery, etc.

### DISCLOSURE

### Technical Problem

Technology providing fast link setup (or fast session setup) is required when many users substantially simultaneously attempt network access or a very large number of terminals substantially simultaneously a random access procedure, as described above. However, a detailed scheme for fast link setup has not yet been provided.

An object of the present invention devised to solve the problem lies in a method for remarkably decreasing a time required for a generic advertisement service (GAS) procedure by optimizing the GAS procedure, association operations and the like and/or increasing speeds thereof for fast link setup.

The technical problems solved by the present invention are not limited to the above technical problems and those skilled in the art may understand other technical problems from the following description.

### Technical Solution

The object of the present invention can be achieved by providing a method for performing, by a station (STA), fast link setup in a wireless communication system, including: transmitting, to an access point (AP), a request frame including a generic advertisement service (GAS) configuration change query; and receiving, from the AP, a response frame including response information with respect to the GAS configuration change query, wherein the response information includes GAS procedure skip indication information when AS information stored in the STA matches GAS information stored in the AP.

In another aspect of the present invention, provided herein is an STA for performing fast link setup in a wireless communication system, including: a transceiver; and a processor, wherein the processor is configured to transmit, to an AP, a request frame including a GAS configuration change query using the transceiver and to receive, from the AP, a response frame including response information with respect to the GAS configuration change query using the transceiver, wherein the response information includes GAS procedure skip indication information when AS information stored in the STA matches GAS information stored in the AP.

The following is commonly applicable to the aforementioned embodiments of the present invention.

The response information may include one or more of a GAS procedure perform indicator, changed GAS information and association deferment indication information when the AS information stored in the STA does not match the GAS information stored in the AP.

An association request frame may be transmitted from the STA after a predetermined time when the response information includes the association deferment indication information.

The association request frame may be transmitted using the changed GAS information included in the response frame.

The association deferment indication information may be represented using a status code of the response frame.

The GAS information stored in the STA may be service information of an access network, the service information being obtained by the STA through request and response procedures with respect to an advertisement server (AS) of the access network via the AP.

The request and response procedures of the STA with respect to the AS may be performed according to an access network query protocol (ANQP).

The GAS information stored in the AP may be information obtained from an AS of an access network before the AP receives the request frame or GAS query information obtained through request and response procedures with respect to the AS after the AP receives the request frame.

The AP may determine whether the AS information stored in the STA matches the GAS information stored in the AP.

The request frame may include one or more of an association request frame, a reassociation request frame and a probe request frame.

The probe request frame may include a service set identifier (SSID), wherein the AP determines whether the AS information stored in the STA matches the GAS information stored in the AP when the SSID matches an SSID of the AP.

The response frame may include one or more of an association response frame, a reassociation response frame, a probe response frame and an association ACK frame.

The method may further include: the STA performing scanning and discovering the AP; the STA transmitting a GAS initial request frame to the AP; and the STA receiving a GAS initial response frame from the AP.

The AP may request the AS to provide GAS query information upon reception of the GAS initial request frame from the STA, and the AP may transmit the GAS query information to the STA through the GAS initial response frame upon acquisition of the GAS query information from the AS.

The above description and the following detailed description of the present invention are exemplary and are for additional explanation of the invention disclosed in the claims.

### Advantageous Effects

According to the present invention, it is possible to provide a method and an apparatus for remarkably decreasing a time required for a GAS procedure by optimizing the GAS procedure, association operations and the like and/or increasing speeds thereof, thereby performing or supporting fast link setup.

The effects of the present invention are not limited to the above-described effects and other effects which are not described herein will become apparent to those skilled in the art from the following description.

### DESCRIPTION OF DRAWINGS

The accompanying drawings, which are included to provide a further understanding of the invention, illustrate embodiments of the invention and together with the description serve to explain the principle of the invention. In the drawings:

FIG. 1 illustrates an exemplary configuration of an IEEE 802.11 system to which the present invention is applicable;

FIG. 2 illustrates another exemplary configuration of an IEEE 802.11 system to which the present invention is applicable;

FIG. 3 illustrates another exemplary configuration of an IEEE 802.11 system to which the present invention is applicable;

FIG. 4 illustrates an exemplary configuration of a WLAN system;

FIG. 5 illustrates a general link setup procedure;

FIG. 6 illustrates state transition of an STA;

FIG. 7 illustrates a GAS procedure;

FIG. 8 illustrates an example of an enhanced GAS procedure provided by the present invention;

FIG. 9 illustrates another example of the enhanced GAS procedure provided by the present invention;

FIG. 10 illustrates an example of an enhanced association operation according to the present invention;

FIG. 11 illustrates another example of the enhanced association operation according to the present invention;

FIGS. 12 and 13 illustrate formats of new information elements provided by the present invention;

FIG. 14 is a block diagram illustrating exemplary configurations of an AP and an STA according to an embodiment of the present invention; and

FIG. 15 illustrates an exemplary configuration of a processor of an AP or an STA according to an embodiment of the present invention.

### BEST MODE

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

Embodiments described hereinbelow are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment.

Specific terms used in the embodiments of the present invention are provided to aid in understanding of the present invention. These specific terms may be replaced with other terms within the scope and spirit of the present invention.

In some cases, to prevent the concept of the present invention from being obscured, structures and apparatuses of the known art will be omitted, or will be shown in the form of a block diagram based on main functions of each structure and apparatus. In addition, wherever possible, the same reference numbers will be used throughout the drawings and the specification to refer to the same or like parts.

The embodiments of the present invention can be supported by standard documents disclosed for at least one of wireless access systems, Institute of Electrical and Electronics Engineers (IEEE) 802, 3GPP, 3GPP LTE, LTE-A, and 3GPP2. Steps or parts that are not described to clarify the technical features of the present invention can be supported by those documents. Further, all terms as set forth herein can be explained by the standard documents.

Techniques described herein can be used in various wireless access systems such as Code Division Multiple Access (CDMA), Frequency Division Multiple Access (FDMA), Time Division Multiple Access (TDMA), Orthogonal Frequency Division Multiple Access (OFDMA), Single Carrier-Frequency Division Multiple Access (SC-FDMA), etc. CDMA may be implemented as a radio technology such as Universal Terrestrial Radio Access (UTRA) or CDMA2000. TDMA may be implemented as a radio technology such as Global System for Mobile communications (GSM)/General Packet Radio Service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, Evolved-UTRA (E-UTRA) etc. For clarity, this application focuses on the IEEE 802.11 system. However, the technical features of the present invention are not limited thereto.

Configuration of WLAN System

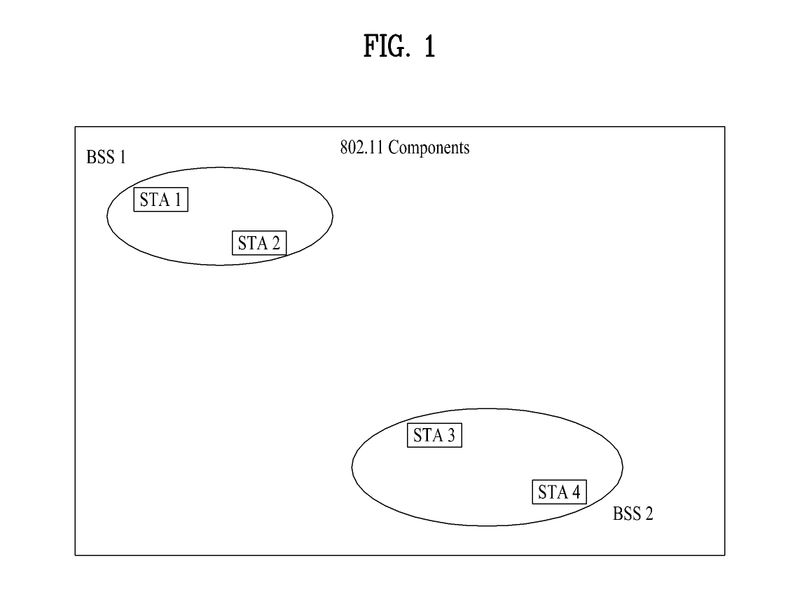

FIG. 1 illustrates an exemplary configuration of an IEEE 802.11 system to which the present invention is applicable.

IEEE 802.11 can be composed of a plurality of components and provide a WLAN supporting STA mobility transparent for higher layers according to interaction of the components. A basic service set (BSS) may correspond to a basic component block in an IEEE 802.11 LAN. FIG. 1 shows 2 BSSs (BSS1 and BSS2) each of which includes 2 STAs as members (STA1 and STA2 being included in BSS1 and STA3 and STA4 being included in BSS2). In FIG. 1, an oval that defines a BSS indicates a coverage area in which STAs belonging to the corresponding BSS perform communication. This area may be called a basic service area (BSA). When an STA moves out of the BSA, the STA cannot directly communicate with other STAs in the BSA.

A most basic BSS in the IEEE 802.11 LAN is an independent BSS (IBSS). For example, the IBSS can have a minimum configuration including only 2 STAs. The IBSS has a simplest form and corresponds to the BSS (BSS1 or BSS2) shown in FIG. 1, in which components other than STA are omitted. This configuration is possible when STAs can directly communicate with each other. This type of LAN can be configured as necessary rather than being previously designed and configured and may be called an ad-hoc network.

When an STA is turned on or off, or enters or exits the coverage of a BSS, membership of the STA in the BSS can be dynamically changed. To become a member of the BSS, the STA can join the BSS using a synchronization process. To access all services based on the BSS, the STA needs to associate with the BSS. Association may be dynamically set and may use a distribution system service (DSS).

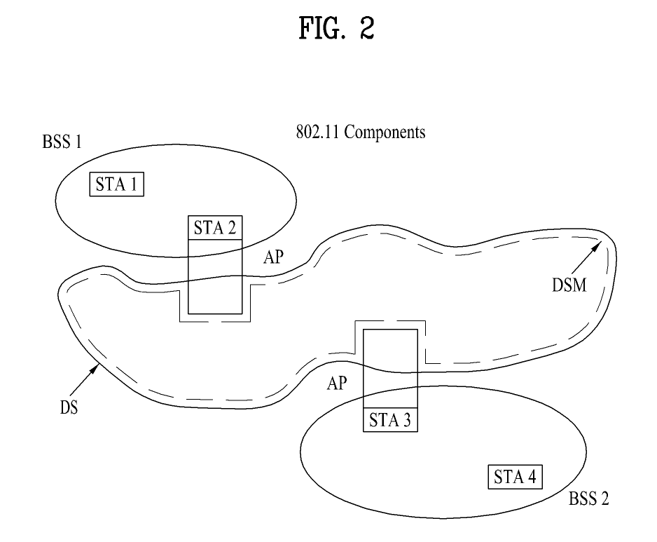

FIG. 2 illustrates another exemplary configuration of an IEEE 802.11 system to which the present invention is applicable. FIG. 2 shows a distribution system (DS), a distribution system medium (DSM) and an access point (AP) in addition to the configuration of FIG. 1.

In a LAN, a direct station-to-station distance may be limited by PHY performance. While this distance limit can be sufficient in some cases, communication between stations having a long distance therebetween may be needed in some cases. The DS may be configured to support an extended coverage.

The DS refers to a structure in which BSSs are connected to each other. Specifically, BSSs may be present as components of an extended form of a network composed of a plurality of BSSs rather than being independently present as shown in FIG. 1.

The DS is a logical concept and may be specified by characteristics of the DSM. IEEE 802.11 logically discriminates a wireless medium (WM) from the DSM. The logical media are used for different purposes and used by different components. IEEE 802.11 does not limit the media as the same medium or different media. The fact that plural media are logically different from each other can explain flexibility of IEEE 802.11 LAN (DS structure or other network structures). That is, the IEEE 802.11 LAN can be implemented in various manners and physical characteristics of implementations can independently specify corresponding LAN structures.

The DS can support mobile devices by providing seamless integration of a plurality of BSSs and logical services necessary to handle addresses to a destination.

The AP refers to an entity that enables associated STAs to access the DS through a WM and has STA functionality. Data can be transmitted between a BSS and the DS through the AP. For example, STA2 and STA3 shown in FIG. 2 have STA functionality and provide a function of enabling associated STAs (STA1 and STA4) to access the DS. Furthermore, all APs are addressable entities because they basically correspond to an STA. An address used by an AP for communication on the WM is not necessarily equal to an address used by the AP for communication on the DSM.

Data transmitted from one of STAs associated with an AP to an STA address of the AP can be received at an uncontrolled port at all times and processed by an IEEE 802.1X port access entity. Furthermore, the transmitted data (or frame) can be delivered to the DS when a controlled port is authenticated.

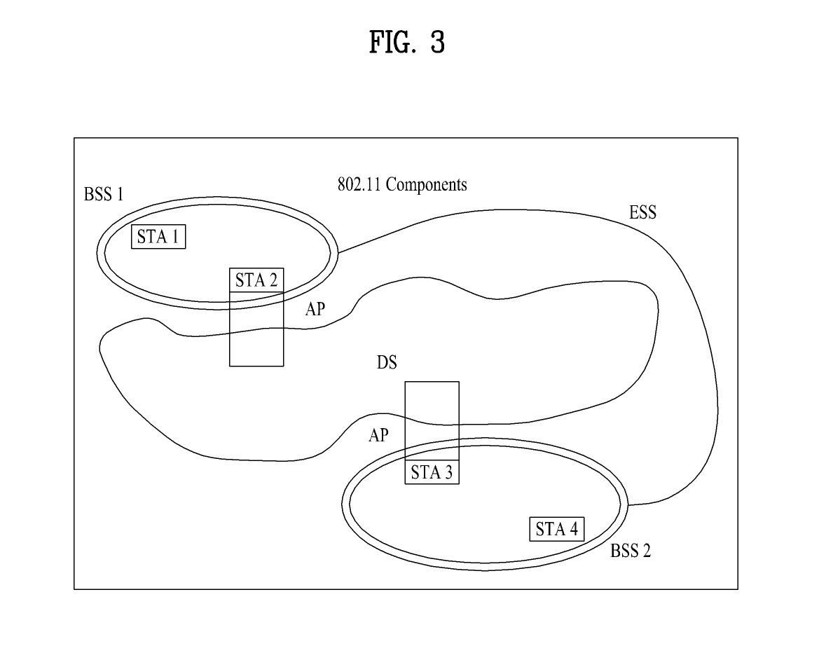

FIG. 3 illustrates another exemplary configuration of an IEEE 802.11 system to which the present invention is applicable. FIG. 3 shows an extended service set (ESS) for providing an extended coverage in addition to the configuration of FIG. 2.

A wireless network having an arbitrary size and complexity may be composed of a DS and BSSs. This type of network is called an ESS network in IEEE 802.11. The ESS may correspond to a set of BSSs connected to a DS. However, the ESS does not include the DS. The ESS network looks like an IBSS network at a logical link control (LLC) layer. STAs belonging to the ESS can communicate with each other and mobile STAs can move from a BSS to another BSS (in the same ESS) transparently to LCC.

IEEE 802.11 does not define relative physical positions of BSSs in FIG. 3 and the BSSs may be located as follows. The BSSs can partially overlap, which is a structure normally used to provide continuous coverage. The BSSs may not be physically connected to each other and there is a limit on the logical distance between the BSSs. In addition, the BSSs may be physically located at the same position in order to provide redundancy. Furthermore, one (or more) IBSS or ESS networks may be physically located in the same space as one (or more ESS) network. This may correspond to an ESS network form when an ad-hoc network operates in the location of the ESS network, IEEE 802.11 networks, which physically overlap, are configured by different organizations or two or more different access and security policies are needed at the same position.

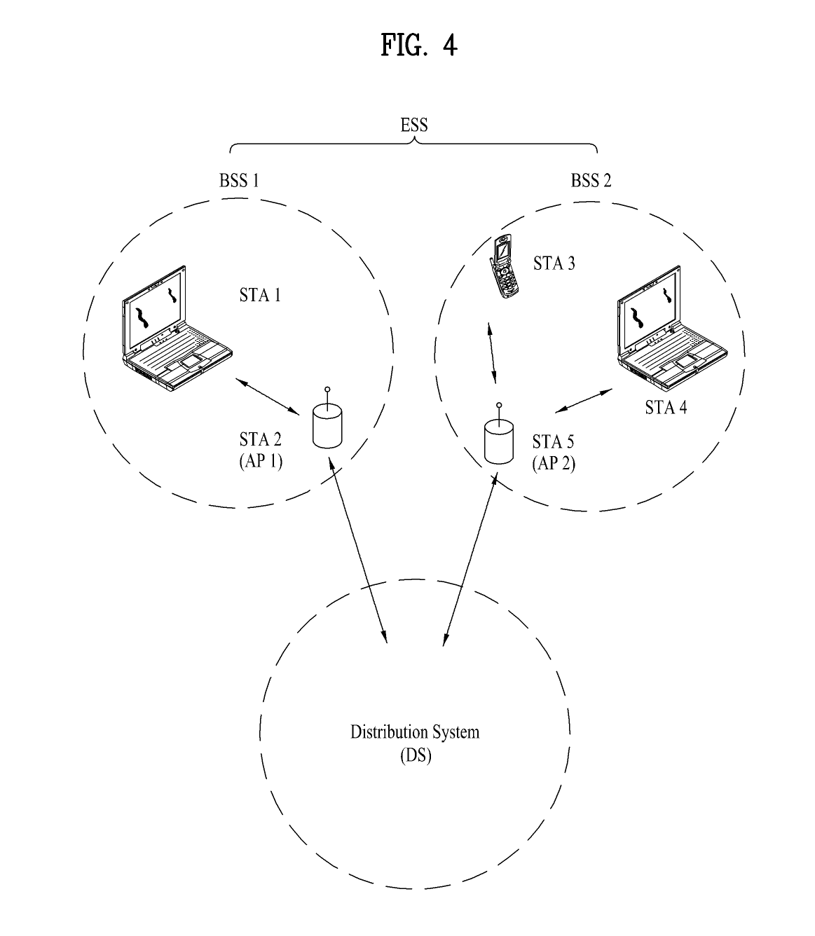

FIG. 4 illustrates an exemplary configuration of a WLAN system. FIG. 4 shows an example of a BSS based on a structure including a DS.

In the example of FIG. 4, BSS1 and BSS2 constitute an ESS. In the WLAN system, STAs are devices operating according to MAC/PHY regulations of IEEE 802.11. The STAs include an AP STA and a non-AP STA. The non-AP STA corresponds to a device directly handled by a user, such as a laptop computer, a cellular phone, etc. In the example of FIG. 4, STA1, STA3 and STA4 correspond to the non-AP STA and STA2 and STA5 correspond to the AP STA.

In the following description, the non-AP STA may be called a terminal, wireless transmit/receive unit (WTRU), user equipment (UE), mobile station (MS), motile terminal, mobile subscriber station (MSS), etc. The AP corresponds to a base station (BS), node-B, evolved node-B, base transceiver system (BTS), femto BS, etc in other wireless communication fields.

Link Setup Procedure

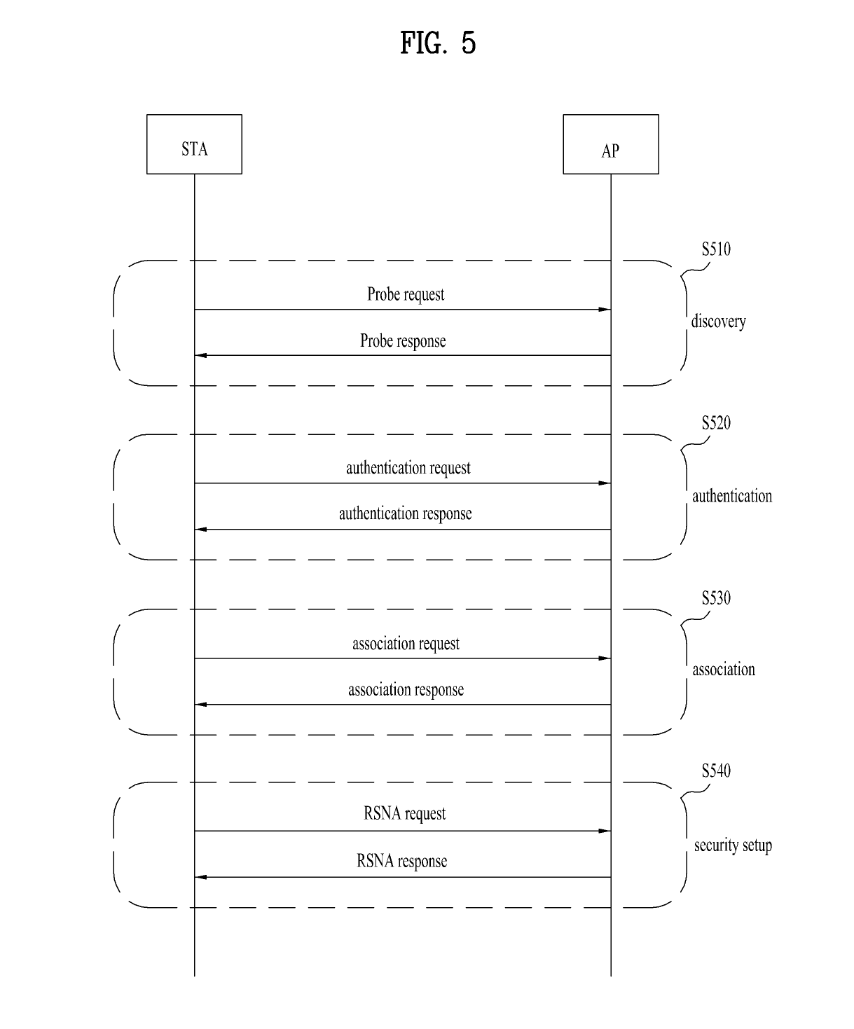

FIG. 5 illustrates a general link setup procedure.

To sets up a link to a network and transmit/receive data, an STA needs to discover the network, perform authentication, establish association and pass through an authentication procedure for security. The link setup procedure may be called a session initiation procedure and a session setup procedure. In addition, discovery, authentication, association and security establishment of the link setup procedure may be called an association procedure.

An exemplary link setup procedure will now be described with reference to FIG. 5.

The STA may discover a network in step S510. Network discovery may include a scanning operation of the STA. That is, the STA needs to discover a network that can participate in communication in order to access the network. The STA needs to identify a compatible network prior to participating in a wireless network. A procedure of identifying a network present in a specific area is referred to as scanning.

Scanning includes active scanning and passive scanning.

FIG. 5 illustrates network discovery operation including active scanning. The STA performing active scanning transmits a probe request frame in order to search surrounding APs while changing channels and waits for a response to the probe request frame. A responder transmits a probe response frame in response to the probe request frame to the STA. Here, the responder may be an STA that has finally transmitted a beacon frame in a BSS of a channel being scanned. An AP corresponds to a responder in a BSS since the AP transmits a beacon frame, whereas a responder is not fixed in an IBSS since STAs in the IBSS transmit a beacon frame in rotation. For example, an STA, which has transmitted a probe request frame on channel #1 and has received a probe response frame on channel #1, may store BSS related information included in the received probe response frame, move to the next channel (e.g. channel #2) and perform scanning (i.e. probe request/response transmission and reception on channel #2) in the same manner.

The scanning operation may be performed in a passive manner, which is not shown in FIG. 5. An STA performing passive scanning waits for a beacon frame while changing channels. The beacon frame, one of management frames in IEEE 802.11, indicates presence of a wireless network and is periodically transmitted to the STA performing scanning to enable the STA to discover and participate in the wireless network. An AP periodically transmits the beacon frame in the BSS, whereas STAs in the IBSS transmit the beacon frame in rotation in the case of IBSS. Upon reception of the beacon frame, the STA performing scanning stores information about the BSS, included in the beacon frame, and records beacon frame information in each channel while moving to another channel. The STA that has received the beacon frame may store BSS related information included in the received beacon frame, move to the next channel and perform scanning on the next channel through the same method.

Comparing active scanning with passive scanning, active scanning has advantages of smaller delay and lower power consumption than passive scanning.

Upon discovery of the network, authentication may be performed on the STA in step S520. This authentication procedure may be referred to as first authentication to be discriminated from security setup operation of step S540, which will be described later.

Authentication includes a procedure through which the STA transmits an authentication request frame to the AP and a procedure through which the AP transmits an authentication response frame to the STA in response to the authentication request frame. An authentication frame used for authentication request/response corresponds to a management frame and may include information as shown in Table 1.

TABLE 1

| Order | Information | Notes |
|---|---|---|
| 1 | Authentication algorithm | |
| | number | |
| 2 | Authentication transaction | |
| | sequence number | |
| 3 | Status code | The status code information is reserved in certain |
| | | Authentication frames. |
| 4 | Challenge text | The challenge text element is present only in certain |
| | | Authentication frames. |
| 5 | RSN | The RSNE is present in the FT Authentication frames. |
| 6 | Mobility Domain | The MDE is present in the FT Authentication frames. |
| 7 | Fast BSS Transition | An FTE is present in the FT Authentication frames. |
| 8 | Timeout Interval | A Timeout Interval element (TIE) containing the |
| | (reassociation deadline) | reassociation deadline interval is present in the FT |
| | | Authentication frames. |
| 9 | RIC | A Resource Information Container, containing a |
| | | variable number of elements, is present in the FT |
| | | Authentication frames. |
| 10 | Finite Cyclic Group | An unsigned integer indicating a finite cyclic group. |
| | | This is present in SAE authentication frames |
| 11 | Anti-Clogging Token | A random bit-string used for anti-clogging purposes. |
| | | This is present in SAE authentication frames. |
| 12 | Send-Confirm | A binary encoding of an integer used for anti-replay |
| | | purposes. This is present in SAE authentication frames |
| 13 | Scalar | An unsigned integer encoded. This is present in SAE |
| | | authentication frames |
| 14 | Element | A field element from a finite field encoded. This is |
| | | present in SAE authentication frames |
| 15 | Confirm | An unsigned integer encoded. This is present in SAE |
| | | authentication frames |
| Last | Vendor Specific | One or more vendor-specific elements are optionally |
| | | present. These elements follow all other elements. |

In Table 1, the authentication algorithm number field indicates a single authentication algorithm, and has a length of 2 octets. For example, authentication algorithm number field values 0, 1, 2 and 3 respectively indicate an open system, a shared key, fast BSS transition and simultaneous authentication of equals (SAE).

The authentication transaction sequence number field indicates a current status from among multiple transaction steps and has a length of 2 octets.

The status code field is used in a response frame, indicates success or failure of a requested operation (e.g. authentication request) and has a length of 2 octets.

The challenge text field includes a challenge text in authentication exchange and has a length determined according to authentication algorithm and transaction sequence number.

The RSN (Robust Security Network) field includes cipher related information and has a length of up to 255 octets. An RSNE (RSN Element) is included in an FT (Fast BSS Transition) authentication frame. The mobility domain field includes mobility domain identifier MD ID, FT capability and policy fields and may be used for an AP to advertise an AP group (i.e. a set of APs that form a mobility domain) to which the AP belongs. The fast BSS transition field includes information necessary to perform an FT authentication sequence during fast BSS transition in an RSN. The timeout interval field includes a reassociation deadline interval. The resource information container (RIC) field refers to a set of one or more elements related to a resource request/response and may include a varying number of elements (i.e. elements indicating resources).

The finite cyclic group field indicates a cryptographic group used in SAE exchange and has an unsigned integer value indicating a finite cyclic group. The anti-clogging token field is used for SAE authentication for protection against denial-of-service and is composed of a random bit string. The send-confirm field is used for response prevention in SAE authentication and has a binary coded integer. The scalar field is used for exchange cipher related information in SAE authentication and has an encoded unsigned integer. The element field is used for exchange of a finite field element in SAE authentication. The confirm field is used to verify possession of an encryption key in SAE authentication and has an encoded unsigned integer.

The vendor specific field may be used for vendor-specific information that is not defined in IEEE 802.11.

Table 1 shows some information that may be included in an authentication request/response frame and the authentication request/response frame may further include additional information.

The STA may transmit the authentication request frame including one or more fields shown in Table to the AP. That AP may determine to permit authentication of the STA on the basis of information included in the received authentication request frame. The AP may provide an authentication result to the STA through the authentication response frame including one or more fields shown in Table 1.

Upon successful authentication of the STA, association may be performed in step S530. Association includes a procedure through which the STA transmits an association request frame to the AP and a procedure through which the AP transmits an association response frame to the STA in response to the association request frame.

For example, the association request frame may include information related to various capabilities, a beacon listen interval, a service set identifier (SSID), supported rates, supported channels, RSN, mobility domain, supported operating classes, TIM (Traffic Indication Map) broadcast request, interworking service capability, etc.

For example, the association response frame may include information related to various capabilities, a status code, AID (Association ID), supported rates, EDCA (Enhanced Distributed Channel Access) parameter set, RCPI (Received Channel Power Indicator), RSNI (Received Signal to Noise Indicator), mobility domain, timeout interval (association comeback time), overlapping BSS scan parameter, TIM broadcast response, QoS map, etc.

The aforementioned information is part of information that may be included in the association request/response frame and additional information may be further included in the association request/response frame.

Upon successful association of the STA with the network, security setup may be performed in step S540. Security setup in step S540 may be regarded as authentication through an RSNA (Robust Security Network Association) request/response. Authentication of step S520 may be referred to as first authentication and security setup of step S540 may be referred to as authentication.

Security setup of step S540 may include private key setup through 4-way handshaking using an EAPOL (Extensible Authentication Protocol over LAN) frame. In addition, security setup may be performed according to a security scheme that is not defined in IEEE 802.11.

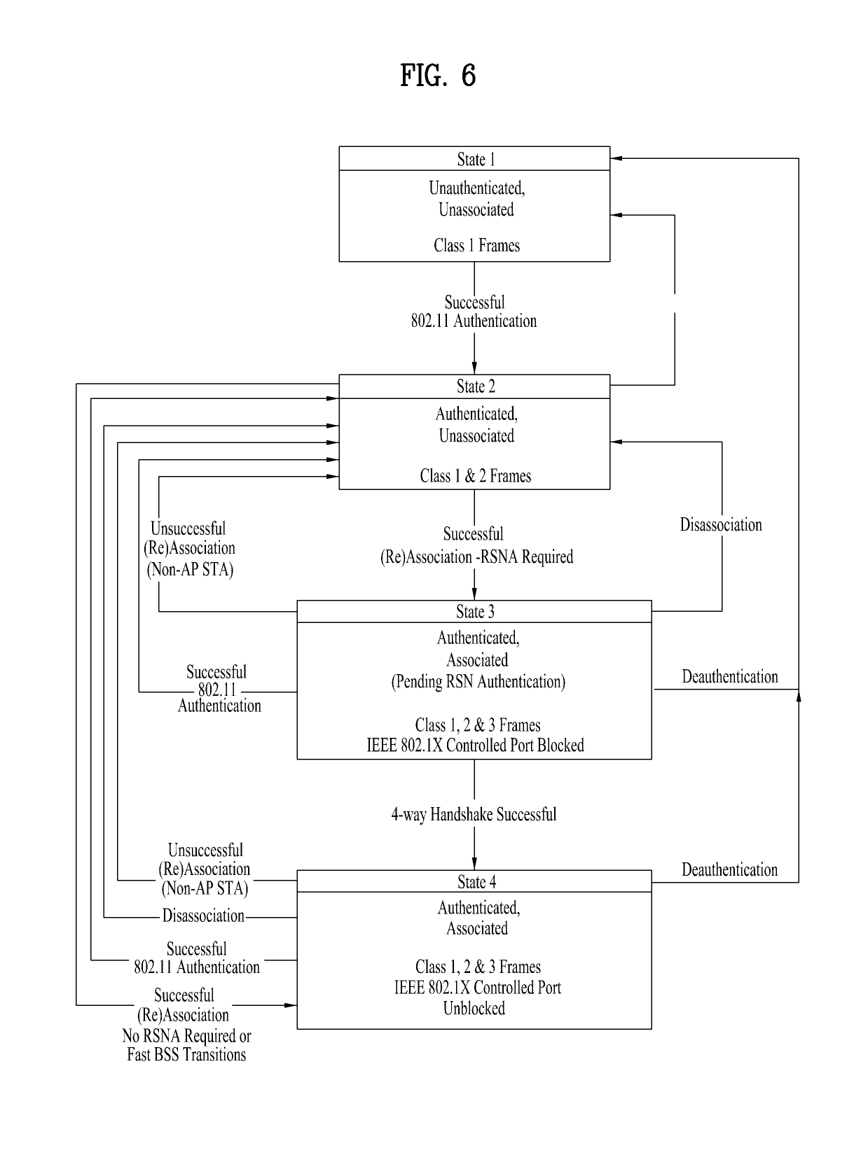

FIG. 6 illustrates the concept of state transition of an STA. FIG. 6 shows only events causing state transition for clarity.

State 1 is an unauthenticated and unassociated state of the STA. The STA in this state can transmit/receive class-1 frames only to/from other STAs. The class-1 frames include management frames such as a probe request/response frame, beacon frame, authentication frame, deauthentication frame and the like, for example.

Upon successful authentication of the STA in state 1 (e.g. authentication corresponding to 5520 of FIG. 5), station 1 is changed to state 2. That is, state 2 is an authenticated but unassociated state. The STA in state 2 can transmit/receive class-1 and class-2 frames only to/from other STAs. The class-2 frames include management frames such as an association request/response frame, reassociation request/response frame, diassociation frame and the like, for example.

When the STA in state 2 is deauthenticated, state 2 is changed to state 1. When the STA in state 2 is successfully associated and RSNA is not required or in the case of fast BSS transition, state 2 is directly changed to state 4.

Upon successful association (or reassociation) of the STA in state 2, state 2 is changed to state 3. That is, state 3 is an authenticated and associated state in which RSNA authentication (e.g. security setup corresponding to step S540 of FIG. 5) is not completed. While the STA can transmit/receive class-1, 2 and 3 frames to/from other STAs in state 3, an IEEE 802.1x control port is blocked. Class-3 frames include management frames such as a data frame, action frame and the like and control frames such as a block ACK frame and the like, transmitted/received in an infrastructure BSS.

When the STA is deassociated or fails to be associated in state 3, state 3 is returned to state 2. When the STA is deauthenticated in state 3, state 3 is returned to state 1.

Upon successful 4-way handshaking of the STA in state 3, state 3 is changed to state 4. In state 4, the STA is authenticated and associated and thus can transmit class-1, 2 and 3 frames, and the IEEE 802.1x control port is unblocked.

When the STA is deassociated or fails to be associated in state 4, state 4 is returned to state 2. When the STA is deauthenticated in state 4, state 4 is returned to state 1.

GAS (Generic Advertisement Service) Procedure

A method of advertising an access network type (e.g. private network, free network, charged network, etc.), roaming consortium, location information and the like is used for an STA to discover and select an appropriate network prior to association with an AP (e.g. a system according to IEEE 802.11u standards). In addition, GAS that enables an STA to transmit/receive an advertisement protocol frame (e.g. second layer (Layer 2) or MAC frame) to/from a network server prior to authentication may be used. According to GAS, an AP may function to relay a query of the STA to a network server (e.g. advertisement server (AS)) and to transmit a response from the network server to the STA. In addition, an access network query protocol (ANQP) may be used to acquire various types of network information that the STA desires.

Specifically, the ANQP may be indicated in a GAS query frame to request information about an access network that the STA desires. Accordingly, the STA can obtain network service information (e.g. service information provided by an IBSS, local access service information, available subscription service provider, external network information, etc.) that is not provided through a beacon frame or a probe response frame.

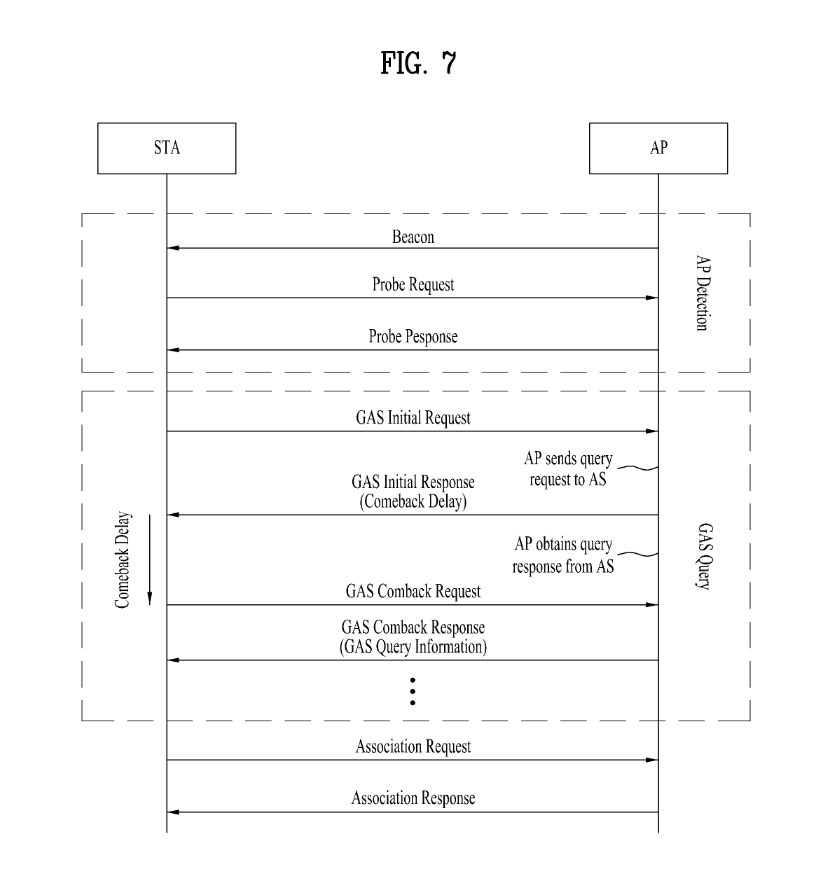

FIG. 7 illustrates a GAS procedure.

An STA may detect an AP by performing passive scanning of receiving a beacon frame or active scanning of transmitting a probe request frame and receiving a frame response frame. The beacon frame or the probe response frame may include information such as an interworking element, a roaming consortium element and the like.

To acquire desired additional network information after detection of the AP, the STA may transmit a GAS initial request frame to the AP. The GAS initial request frame may include a dialog token, request IE and the like. Accordingly, the AP may transmit a GAS query request to an advertisement server (AS). When the AP does not receive a GAS query response from the AS for a predetermined time, the AP may transmit a GAS initial response frame including a dialog token, comeback delay information and the like to the STA. Accordingly, the STA may transmit a GAS comeback request frame including a dialog token to the AP after waiting for comeback delay. The AP may receive the GAS query response from the AS while the STA waits for the comeback delay. In this case, the AP may transmit a GAS comeback response frame including a dialog token, GAS query information and the like in response to the GAS comeback request of the STA.

Upon acquisition of network information through GAS query operation, the STA may associate with the AP of the corresponding network.

Enhanced GAS Procedure

In the aforementioned link setup scheme defined in the current wireless communication system (e.g. WLAN system), message exchange through a beacon or probe request/response (i.e. network discovery), authentication request/response (i.e. first authentication), association request/response (i.e. association) and RSNA request/response (i.e. authentication) needs to be performed.

In the conventional link setup procedure, the GAS procedure needs to be performed in order to obtain network information that the STA desires. However, an unnecessary GAS procedure may be performed when the STA knows the network information, resulting in a delay in the initial link setup procedure. For example, when the STA is reassociated with an AP with which the STA was associated, the STA can perform the GAS procedure again according to the operation defined in the conventional wireless communication system. However, when network service information that the STA desires has not been changed/updated, the STA does not newly obtain information through the GAS procedure and the GAS procedure become unnecessary. Accordingly, the present invention provides a new GAS operation scheme capable of improving initial link setup speed by preventing/skipping an unnecessary GAS/ANQP procedure.

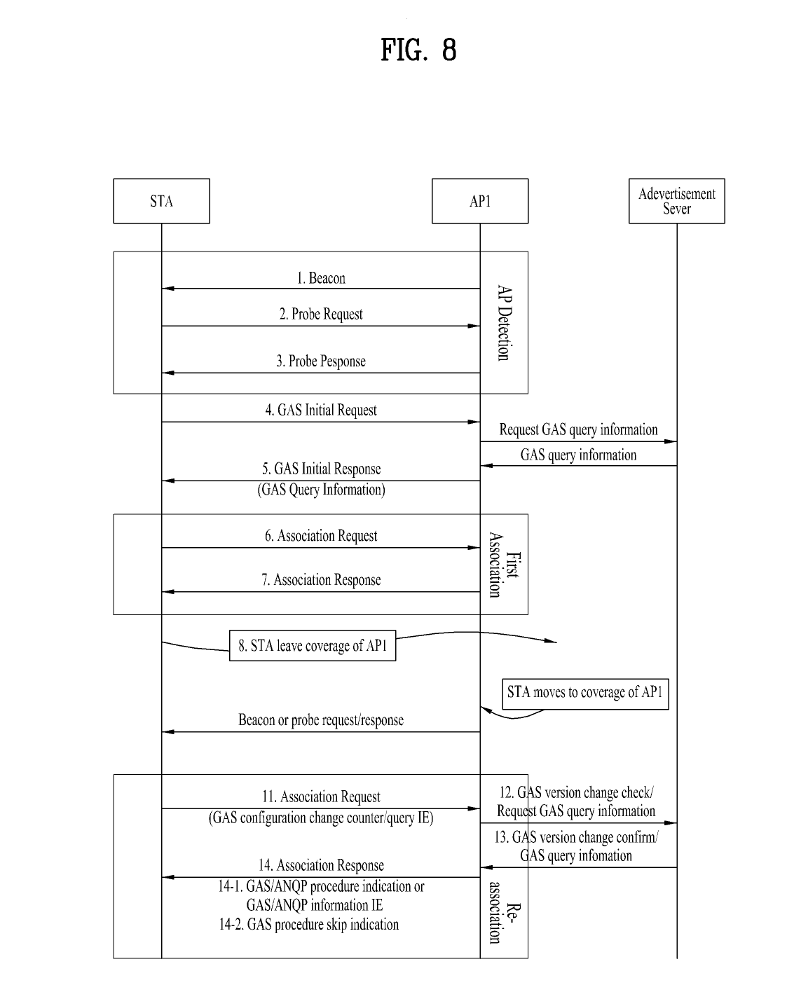

FIG. 8 illustrates an example of an enhanced GAS procedure provided by the present invention.

FIG. 8 illustrates a method of skipping an unnecessary GAS procedure by including GAS configuration change counter and/or GAS configuration change query information in an association request frame. The GAS configuration change counter/query information indicates whether GAS/ANQP information is changed. The GAS configuration change counter information may indicate a value corresponding to a version of the GAS/ANQP information. Changed GAS/ANQP information may have a different GAS configuration change counter value. The GAS configuration change query information is information for inquiring whether GAS/ANQP configuration has been changed and may be regarded as information for requesting a response about whether GAS/ANQP configuration is changed from a receiver (AP or AS).

In steps 1, 2 and 3 of FIG. 8, the STA may discover/detect an AP with which the STA will be associated through reception of a beacon frame or through probe request/response procedure.

In steps 4 and 5 of FIG. 8, the STA may receive GAS/ANQP configuration information (e.g. configuration change counter, GAS/ANQP ID, etc.) along with network service related information through GAS/ANQP procedures prior to association with the AP.

In steps 6 and 7 of FIG. 8, the STA may select AP1 as a preferred AP on the basis of information obtained through the GAS procedure. The STA may perform association with AP1 and access AP1.

In steps 8 and 9 of FIG. 8, it is assumed that the STA leaves the coverage of AP1 and is thus disconnected from AP1 and then enters the coverage of AP1 after a lapse of time.

In step 10 of FIG. 8, the STA may discover/detect an AP to be accessed by performing passive scanning through reception of a beacon frame or active scanning of a probe request/response.

In step 11 of FIG. 8, the STA may select AP1 as an AP to be accessed and perform association with AP1. That is, when steps 6 and 7 correspond to first association, step 11 may be regarded as start of reassociation operation. When the STA performs reassociation with AP1, the STA may include a GAS/ANQP configuration change counter (or GAS/ANQP configuration change query) IE in an association request frame and transmit the association request frame to AP1.

In steps 12 and 13 of FIG. 8, AP1 may check whether GAS version has been changed upon reception of the GAS/ANQP configuration change counter/query IE.

To achieve this, AP1 may obtain GAS/ANQP information from an AS periodically or in an event-triggered manner and locally store and update the GAS/ANQP information. In this case, AP1 may compare the version of the GAS/ANQP information stored therein with the version of GAS/ANQP information stored in the STA (e.g. acquired during the first authentication procedure) to determine whether the two versions match each other, upon reception of the association request frame including a GAS configuration change counter/query from the STA.

Alternatively, upon reception of the association request frame including the GAS configuration change counter/query from the STA, AP1 may request the AS to provide GAS query information and receive the GAS query information from the AS. Accordingly, AP1 may compare the version of the GAS/ANQP information stored in the STA (e.g. acquired during the first authentication procedure) with the version of the GAS/ANQP information obtained from AS to determine whether the two versions match.

Step 14 of FIG. 8 may be performed differently according to whether the version of the GAS/ANQP information stored in the STA corresponds to the version of the GAS/ANQP information stored in AP1 (or obtained from the AS). When the two versions do not match each other, AP1 may transmit, to the STA, an association response frame including indication of execution of a GAS/ANQP procedure or an association response frame including an IE with respect to changed GAS/ANQP information (step 14-1). When the two versions match, AP1 may transmit an association response frame including indication of skipping of the GAS procedure to the STA (step 14-2).

Upon reception of the association response frame, the STA may confirm validity of the GAS/ANQP information stored therein. Accordingly, the STA can perform the GAS/ANQP procedure, change/update the GAS/ANQP information on the basis of the IE containing the GAS/ANQP information, included in the association response frame, or use the GAS/ANQP information stored therein without changing the same.

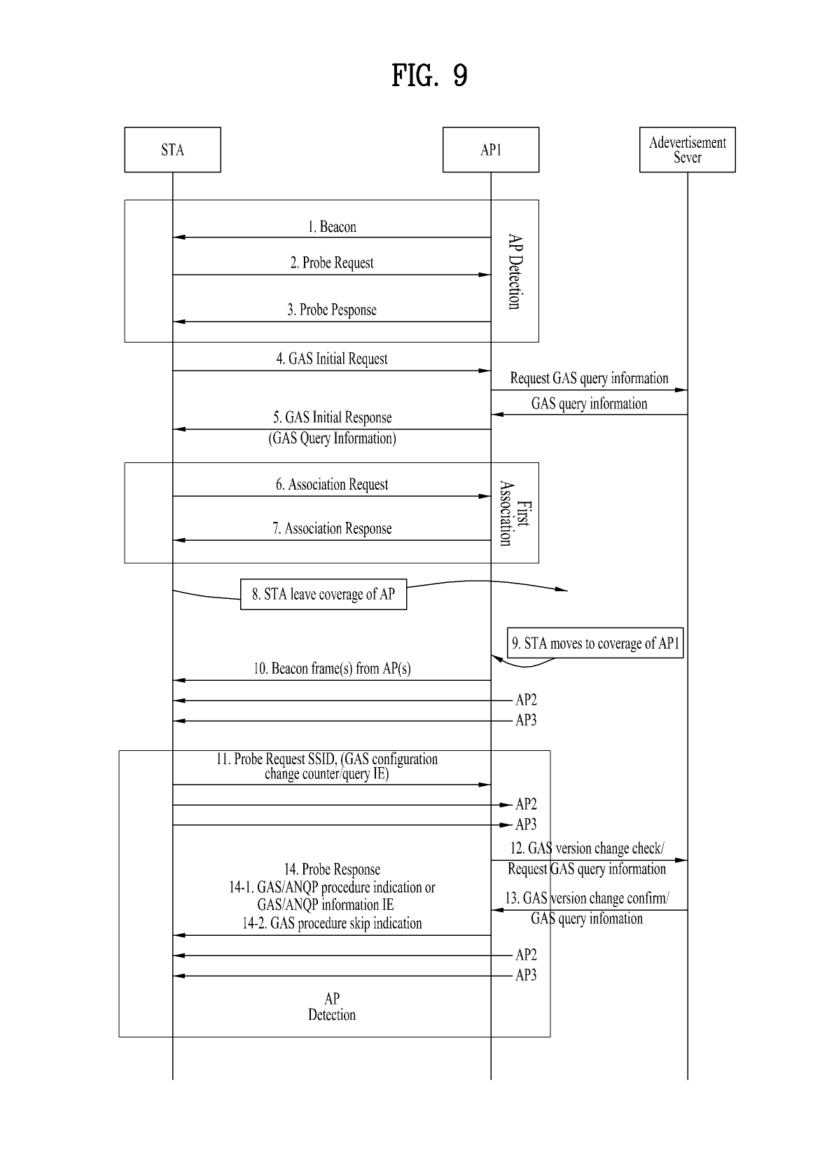

FIG. 9 illustrates another example of the enhanced GAS procedure provided by the present invention.

FIG. 9 illustrates a method of skipping an unnecessary GAS procedure by including GAS configuration change counter (or GAS configuration change query) information in a probe request frame.

Steps 1 to 9 of FIG. 9 correspond to steps 1 to 9 of FIG. 8 and thus redundant description is omitted.

In step 10 of FIG. 9, the STA may receive beacon frames from one or more APs. For example, the STA can respectively receive beacon frames from AP1, AP2 and AP3 to obtain information about AP1, AP2 and AP3.

In step 11 of FIG. 9, the STA may transmit a probe request frame to the one or more APs on the basis of the information about the one or more APs, obtained through the beacon frames, in order to select a preferred AP. The probe request frame may include an SSID (Service Set Identifier) and/or a GAS/ANQP configuration change counter (or GAS/ANQP configuration change query) IE.

In steps 12 and 13 of FIG. 9, upon reception of the probe request frame from the STA, the one or more APs may check whether GAS/ANQP information has been changed (or the version thereof has been changed) when SSID (or SSIDs) thereof corresponds to the SSID included in the probe request frame.

To this end, the one or more APs may obtain GAS/ANQP information from an AS periodically or in an event-triggered manner and locally store and update the GAS/ANQP information. In this case, the one or more APs may compare the version of GAS/ANQP information stored therein with the version of GAS/ANQP information stored in the STA (e.g. acquired during the first authentication procedure) to determine whether the two versions match each other, upon reception of the probe request frame including a GAS configuration change counter/query from the STA.

Alternatively, upon reception of the probe request frame including the GAS configuration change counter/query from the STA, the one or more APs may request the AS to provide GAS query information and receive the GAS query information from the AS. Accordingly, the one or more APs may compare the version of the GAS/ANQP information stored in the STA (e.g. acquired during the first authentication procedure) with the version of the GAS/ANQP information obtained from AS to determine whether the two versions match.

Step 14 of FIG. 9 may be performed differently according to whether the version of the GAS/ANQP information stored in the STA corresponds to the version of the GAS/ANQP information stored in the one or more APs (or obtained from the AS). When the two versions do not match, the one or more APs may transmit, to the STA, a probe response frame including indication of execution of a GAS/ANQP procedure or a probe response frame including an IE with respect to changed GAS/ANQP information (step 14-1). When the two versions correspond to each other, the one or more APs may transmit a probe response frame including indication of skipping of the GAS procedure to the STA (step 14-2).

Upon reception of the association response frame, the STA may confirm validity of the GAS/ANQP information stored therein. Accordingly, the STA can perform the GAS/ANQP procedure, change/update the GAS/ANQP information on the basis of the IE containing the GAS/ANQP information, included in the association response frame, or use the GAS/ANQP information stored therein without changing the same.

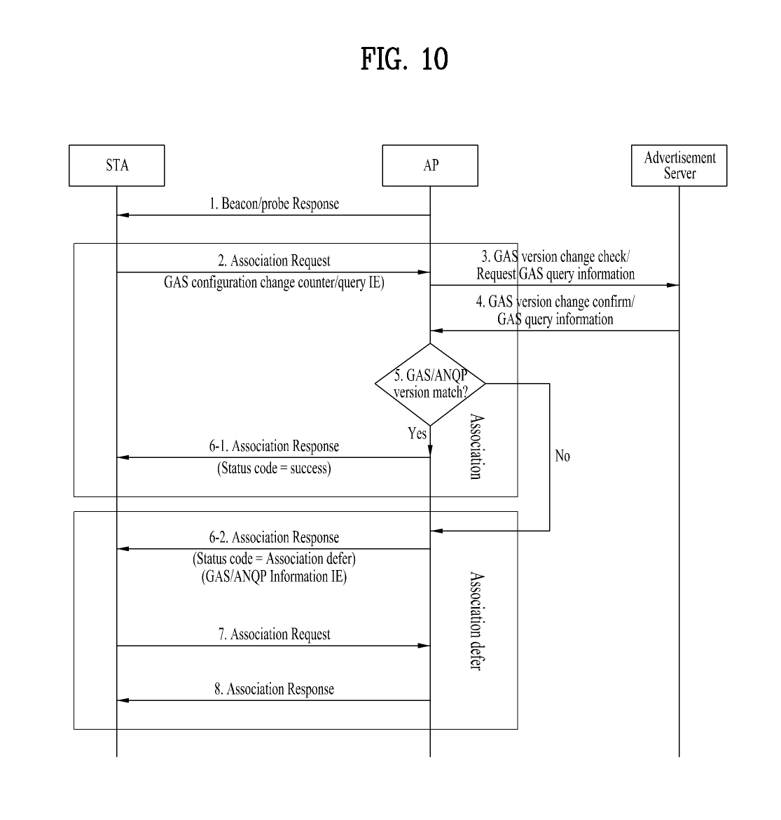

FIG. 10 illustrates an exemplary enhanced association operation according to the present invention.

FIG. 10 illustrates a method of deferring association operation when the version of GAS/ANQP information of the STA does not match the version of GAS/ANQP information of the network/AP. The example of FIG. 8 can achieve an advantageous effect of skipping an unnecessary GAS procedure when the version of GAS/ANQP information of the STA corresponds to the version of GAS/ANQP information of the network/AP. However, when the two versions do not correspond to each other, the STA needs to perform diassociation, perform the GAS/ANQP procedure again and then detect a preferred AP to perform association operation and thus delay may be generated. Accordingly, the present invention provides a method for further decreasing time required for the link setup procedure of the STA by additionally solving problems due to disassociation.

In step 1 of FIG. 10, the STA may discover/detect an AP through scanning (e.g. reception of a beacon frame or reception of a probe response frame in response to a probe request frame).

In step 2 of FIG. 10, the STA may perform association with a preferred AP. For example, the STA may transmit an association request frame including a GAS/ANQP configuration change counter/query IE to the AP.

In steps 3 and 4 of FIG. 10, the AP may check whether the version of GAS information thereof has been changed upon reception of the GAS/ANQP configuration change counter/query IE.

To this end, the AP may obtain GAS/ANQP information from an AS periodically or in an event-triggered manner and locally store and update the GAS/ANQP information. In this case, the AP may compare the version of the GAS/ANQP information stored therein with the version of GAS/ANQP information of the STA to determine whether the two versions correspond to each other, upon reception of the association request frame including the GAS configuration change counter/query from the STA. Alternatively, upon reception of the association request frame including the GAS configuration change counter/query from the STA, the AP may request GAS query information to the AS and receive the GAS query information from the AS. Accordingly, AP1 may compare the version of the GAS/ANQP information of the STA with the version of the GAS/ANQP information obtained from AS to determine whether the two versions correspond to each other.

Step 6-1 of FIG. 10 may be performed when the version of the GAS/ANQP information of the STA corresponds to the version of the GAS/ANQP information of the network/AP, whereas step 6-2 of FIG. 10 may be performed when the two versions do not correspond to each other.

In step 6-1 of FIG. 10, the STA may receive an association response frame from the AP. Here, a status code of the association response frame may be set to a value indicating success. Accordingly, the association procedure of the STA is successfully completed.

In step 6-2 of FIG. 10, the STA may receive an association response frame. Here, a status code of the association response frame may be set to a value indicating “association defer”. Changed/updated GAS/ANQP information may be provided along with the association response frame to the STA. Accordingly, the STA may defer the association procedure. That is, the STA may transmit an association request frame after waiting for a predetermined period of time from when information indicating “association defer” is received.

In steps 7 and 8 of FIG. 10, the STA may transmit the association request frame to the AP (i.e. the AP that has transmitted the association response frame including the information indicating association deferment) or another AP on the basis of the changed GAS/ANQP information (i.e. GAS/ANQP information obtained in step 6-2) and receive an association response frame from the corresponding AP. A status code of the association response frame in step 8 may include a value indicating success or association deferment, and thus step 6-1 or 6-2 may be performed again.

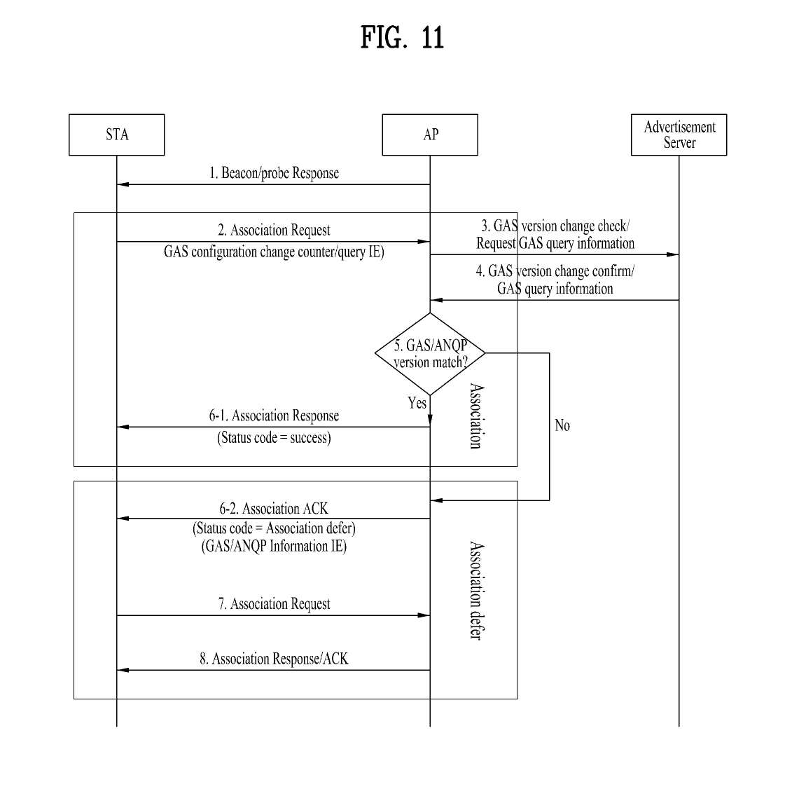

FIG. 11 illustrates another exemplary enhanced association operation according to the present invention.

Since steps 1 to 6-1 of FIG. 11 correspond to steps 1 to 6-1 of FIG. 10, redundant description will be omitted.

In step 6-2 of FIG. 11, the STA may receive an association acknowledgement (ACK) frame from the AP when the version of the GAS/ANQP information of the STA does not match the version of the GAS/ANQP information of the network/AP. A status code of the association ACK frame may be set to a value indicating association deferment. In addition, changed/updated GAS/ANQP information may be provided along with the association ACK frame to the STA. Accordingly, the STA may defer the association procedure. That is, the STA may transmit an association request frame after waiting for a predetermined period of time from when information indicating association deferment is received.

In steps 7 and 8 of FIG. 11, the STA may transmit the association request frame to the AP (i.e. AP that has transmitted the association ACK frame including the information indicating association deferment) or another AP on the basis of the changed GAS/ANQP information (i.e. GAS/ANQP information obtained in step 6-2) and receive an association response frame or an association ACK frame from the corresponding AP. When an association response frame having a status code indicating success is received in step 8, the association operation can be successfully completed. When an association ACK frame having a status code indicating association deferment is received in step 8, the association operation may be deferred again.

In the examples of the present invention, described with reference to FIGS. 10 and 11, the status code indicating association deferment, included in the association response frame or the association ACK frame, can be defined as shown in Table 2.

TABLE 2

| Status code | Name | Meaning |
|---|---|---|
| X | DEFERRED_GAS/ | Association deferred |
| | ANQP_MISMATCHED | due to GAS/ANQP |
| | | information change |

In Table 2, X denotes a status code value and may be set to an arbitrary value that does not correspond to existing status codes indicating other meanings.

An exemplary format of the association ACK frame in the example of FIG. 11 may be defined as shown in Table 3.

TABLE 3

| Order | Information | Note |
|---|---|---|
| 1 | Status code | Status code field is included in a |
| | | response management frame and is |
| | | used to indicate success or failure |
| | | or deferment of a requested operation. |
| 2 | GAS/ANQP | This IE is included when status |
| | information IE | code is set to ‘DEFERRED_GAS/ |
| | | ANQP_MISMATCHED’. |

The association ACK frame may be defined such that the association ACK frame further includes information in addition to the information (or field) shown in Table 3.

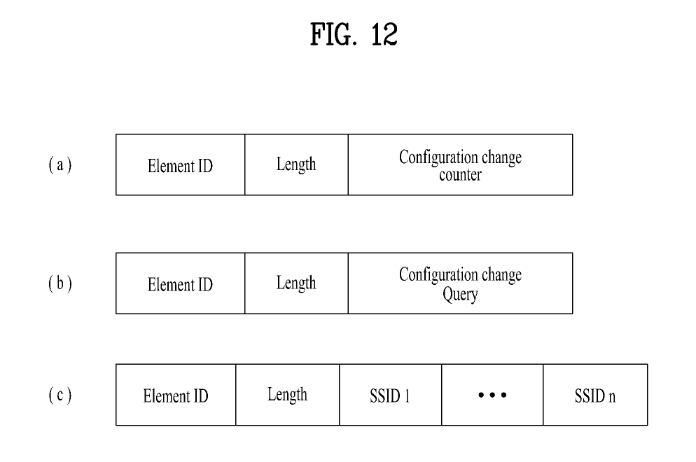

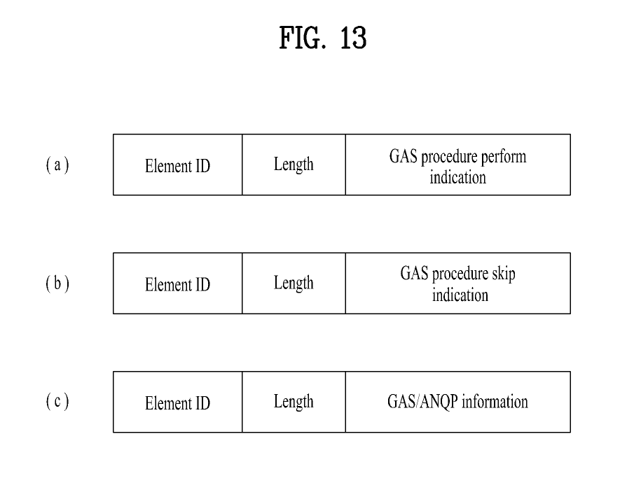

FIGS. 12 and 13 illustrate formats of new IEs provided by the present invention.

FIG. 12(a) shows an exemplary format of a GAS configuration change counter IE. The element ID field may have a length of 1 octet and may be set to a value indicating that the corresponding IE corresponds to GAS configuration change counter information. The length field may be defined to have a length of 1 octet and set to a value indicating the length of the following field. The configuration change counter field may be set to a value indicating the version of GAS/ANQP information of the corresponding STA. The GAS configuration change counter IE may be included in an association request frame and/or a probe request frame.

FIG. 12(b) shows an exemplary format of a GAS configuration change query IE. The element ID field may have a length of 1 octet and may be set to a value indicating that the corresponding IE corresponds to a GAS configuration change query. The length field may be defined to have a length of 1 octet and set to a value indicating the length of the following field. The configuration change query field may be set to a value indicating whether GAS/ANQP configuration change is checked and/or the version of GAS/ANQP information of the corresponding STA. The GAS configuration change query IE may be included in an association request frame and/or a probe request frame.

FIG. 12(c) illustrates an exemplary format of an SSID IE. The element ID field may have a length of 1 octet and may be set to a value indicating that the SSID IE corresponds to an SSID. The length field may be defined to have a length of 1 octet and set to a value indicating the length of the following field. The SSID1, SSID2, . . . , SSIDn fields may be set to values indicating APs that will check whether GAS/ANQP information is changed. When the SSID IE includes only one SSID field, a probe request frame is transmitted (i.e. unicast) to one AP to request the AP to check whether GAS/ANQP information has been changed. When the SSID IE includes a plurality of SSID fields, the probe request frame is transmitted (i.e. multicast) to a plurality of APs to request the APs to check whether GAS/ANQP information has been changed. The SSID IE may be included in the probe request frame.

FIG. 13(a) shows an exemplary format of a GAS procedure perform indication IE. The element ID field may have a length of 1 octet and may be set to a value indicating that the GAS procedure perform indication IE corresponds to GAS procedure perform indication. The length field may be defined to have a length of 1 octet and set to a value indicating the length of the following field. The GAS procedure perform indication field may be set to a value indicating whether the corresponding STA performs a GAS procedure. The GAS procedure perform indication IE may be included in an association response frame and/or a probe response frame.

FIG. 13(b) shows an exemplary format of a GAS procedure skip indication IE. The element ID field may have a length of 1 octet and may be set to a value indicating that the GAS procedure skip indication IE relates to GAS procedure skip indication. The length field may be defined to have a length of 1 octet and set to a value indicating the length of the following field. The GAS procedure skip indication field may be set to a value indicating whether the corresponding STA performs or skips a GAS procedure. The GAS procedure skip indication IE may be included in an association response frame and/or a probe response frame.

FIG. 13(c) shows an exemplary format of a GAS/ANQP information IE. The element ID field may have a length of 1 octet and may be set to a value indicating that the GAS/ANQP information IE corresponds to GAS/ANQP information. The length field may be defined to have a length of 1 octet and set to a value indicating the length of the following field. The GAS/ANQP information field may include network service related information (e.g. service information provided by an IBSS, local access service, available subscription service provider, external network information, etc.) transmitted form an AP to the corresponding STA through a GAS initial response frame or a GAS comeback response frame. The GAS/ANQP information IE may be included in an association response frame and/or a probe response frame.

An unnecessary GAS procedure can be determined and skipped using the aforementioned examples of the present invention and/or IE formats to reduce link setup delay. Considering that GAS/ANQP information is not frequently changed/updated compared to other control information, when a network or an AP informs an STA as to whether the GAS/ANQP information has been changed prior to or during provision of the GAS/ANQP information to the STA, unnecessary control information overhead may be generated. Accordingly, the present invention can employ the method through which the STA quires the network or AP as to whether the GAS/ANQP information has been changed as necessary so as to minimize operation of determining whether the GAS/ANQP information has been changed, thereby reducing a load or delay in operations of the network or AP. Accordingly, link setup delay can be remarkably decreased.

According to the methods provided by the present invention, when GAS/ANQP information stored in the STA differs from GAS/ANQP information of the network or AP, the STA may defer association operation and retransmit the association request frame. Accordingly, time required for operations such as research, reassociation and the like and signaling overhead can be considerably reduced, thereby enabling fast link setup.

The aforementioned enhanced GAS operation and enhanced association operation according to the present invention may be implemented such that the above-described various embodiments of the present invention can be independently applied or two or more thereof can be simultaneously applied, and description of redundant parts is omitted for clarity.

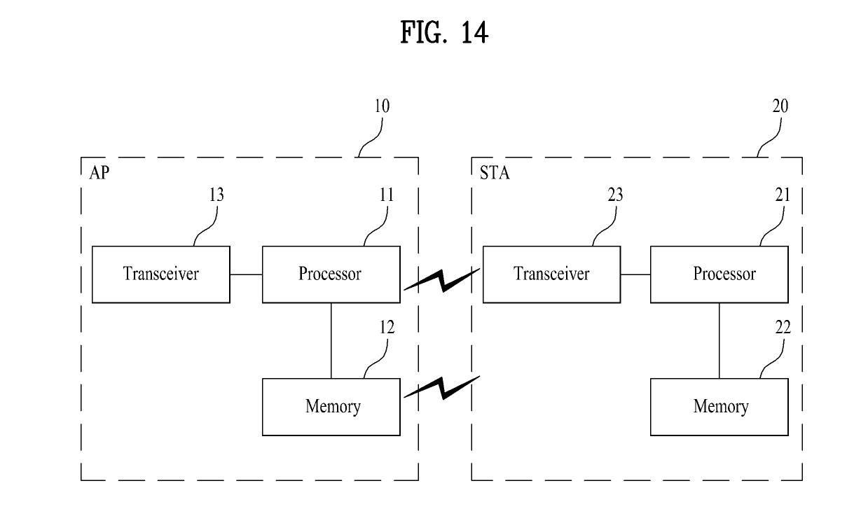

FIG. 14 is a block diagram showing exemplary configurations of an AP (or BS) and an STA (or terminal) according to an embodiment of the present invention.

An AP 10 may include a processor 11, a memory 12 and a transceiver 13. An STA 20 may include a processor 21, a memory 22 and a transceiver 23.

The transceivers 13 and 23 may transmit/receive RF signals and implement a physical layer according to IEEE 802, for example.

The processors 11 and 21 may be connected to the transceivers 13 and 23 and implement the physical layer and/or an MAC layer according to IEEE 802. The processors 11 and 21 may be configured to perform operations according to the aforementioned embodiments of the present invention or combinations of two or more thereof.

In addition, modules for implementing operations of the AP and the STA according to the aforementioned embodiments of the present invention may be stored in the memories 12 and 22 and executed by the processors 11 and 21. The memories 12 and 22 may be included in the processors 11 and 21 or provided to the outside of the processors 11 and 21 and connected to the processors 11 and 21 through known means.

Description of the AP 10 and the STA 20 may be respectively applied to a BS and a terminal in other wireless communication systems (e.g. LTE/LTE-A).

The aforementioned configurations of the AP and STA may be implemented such that the above-described various embodiments of the present invention are independently applied or two or more thereof are simultaneously applied, and description of redundant parts is omitted for clarity.

The embodiments of the present invention may be achieved by various means, for example, hardware, firmware, software, or a combination thereof.

In a hardware configuration, the methods according to the embodiments of the present invention may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the embodiments of the present invention may be implemented in the form of a module, a procedure, a function, etc. For example, software code may be stored in a memory unit and executed by a processor. The memory unit is located at the interior or exterior of the processor and may transmit and receive data to and from the processor via various known means.

The configuration of the processors 11 and 21 from among components of the AP/STA will now be described in more detail.

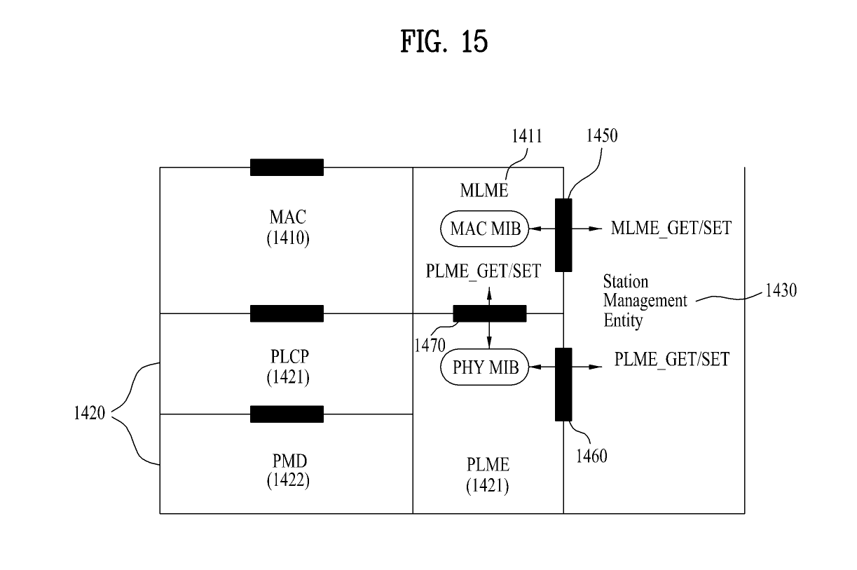

FIG. 15 illustrates an exemplary configuration of the processor of the AP or STA according to an embodiment of the present invention.

The processor 11 or 21 of the AP or STA shown in FIG. 14 may include a plurality of layers. FIG. 15 shows a MAC sublayer 1410 and a physical layer (PHY) 1420 on a data link layer DDL from among the layers. As shown in FIG. 15, the PHY 1420 may include a PLCP (Physical Layer Convergence Procedure) entity 1421 and a PMD (Physical Medium Dependent) entity 1422. Both the MAC sublayer 1410 and PHY 1420 include management entities called MLMEs (MAC sublayer Management Entities) 1411. These entities 1411 and 14121 provide a layer management service interface having a layer management function.

To provide correct MAC operation, a SME (Station Management Entity) 1430 is present in each STA. The SME 1430 is a layer independent entity which can be regarded as being present in a separate management plane or as being off to the side. While functions of the SME 1430 are not described in detail herein, the SME 1430 collects layer-dependent states from various layer management entities (LMEs) and sets layer-specific parameters to similar values. The SME 1430 may execute these functions and implement a standard management protocol on behalf of general system management entities.

The entities shown in FIG. 15 interact in various manners. FIG. 15 illustrates examples of exchanging GET/SET primitives. XX-GET.request primitive is used to request a predetermined MIB attribute (management information based attribute information). XX-GET.confirm primitive is used to return an appropriate MIB attribute information value when a status field indicates “success” and to return error indication in the status field when the status field does not indicate “success”. XX-SET.request primitive is used to request an indicated MIB attribute to be set to a predetermined value. When the MIB attribute indicates a specific operation, the MIB attribute requests the operation to be performed. XX-SET.confirm primitive is used to confirm that the indicated MIB attribute is set to a requested value when the status field indicates “success” and to return error conditions in the status field when the status field does not indicate “success”. When the MIB attribute indicates a specific operation, it is confirmed that the operation has been performed.

As shown in FIG. 15, the MLME 1411 and SME 1430 can exchange various MLME_GET/SET primitives through a MLME SAP 1450. In addition, various PLCM_GET/SET primitives can be exchanged between the PLME 1421 and the SME 1430 through a PLME_SAP 1460 and exchanged between the MLME 1411 and the PLME 1470 through a MLME-PLME_SAP 1470.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

### INDUSTRIAL APPLICABILITY

While the above-described embodiments of the present invention focus on IEEE 802.11, they are applicable to various mobile communication systems in the same manner.

1. A method for performing, by a station (STA), fast link setup in a wireless communication system, comprising:
transmitting, to an access point (AP), a request frame including a generic advertisement service (GAS) configuration change query; and
receiving, from the AP, a response frame including response information with respect to the GAS configuration change query,
wherein the response information includes GAS procedure skip indication information when AS information stored in the STA matches GAS information stored in the AP.

2. The method according to claim 1, wherein the response information includes one or more of a GAS procedure perform indicator, changed GAS information and association deferment indication information when the AS information stored in the STA does not match the GAS information stored in the AP.

3. The method according to claim 2, wherein an association request frame is transmitted from the STA after a predetermined time when the response information includes the association deferment indication information.

4. The method according to claim 3, wherein the association request frame is transmitted using the changed GAS information included in the response frame.

5. The method according to claim 2, wherein the association deferment indication information is represented using a status code of the response frame.

6. The method according to claim 1, wherein the GAS information stored in the STA is service information of an access network, the service information being obtained by the STA through request and response procedures with respect to an advertisement server (AS) of the access network via the AP.

7. The method according to claim 6, wherein the request and response procedures of the STA with respect to the AS are performed according to an access network query protocol (ANQP).

8. The method according to claim 1, wherein the GAS information stored in the AP is information obtained from an AS of an access network before the AP receives the request frame or GAS query information obtained through request and response procedures with respect to the AS after the AP receives the request frame.

9. The method according to claim 1, wherein the AP determines whether the AS information stored in the STA matches the GAS information stored in the AP.

10. The method according to claim 1, wherein the request frame includes one or more of an association request frame, a reassociation request frame and a probe request frame.

11. The method according to claim 10, wherein the probe request frame includes a service set identifier (SSID),
wherein the AP determines whether the AS information stored in the STA matches the GAS information stored in the AP when the SSID matches an SSID of the AP.

12. The method according to claim 1, wherein the response frame includes one or more of an association response frame, a reassociation response frame, a probe response frame and an association ACK frame.

13. The method according to claim 1, further comprising:
the STA performing scanning and discovering the AP;
the STA transmitting a GAS initial request frame to the AP; and
the STA receiving a GAS initial response frame from the AP.

14. The method according to claim 1, wherein the AP requests the AS to provide GAS query information upon reception of the GAS initial request frame from the STA, and the AP transmits the GAS query information to the STA through the GAS initial response frame upon acquisition of the GAS query information from the AS.

15. An STA for performing fast link setup in a wireless communication system, comprising:
a transceiver; and
a processor,
wherein the processor is configured to transmit, to an AP, a request frame including a GAS configuration change query using the transceiver and to receive, from the AP, a response frame including response information with respect to the GAS configuration change query using the transceiver,
wherein the response information includes GAS procedure skip indication information when AS information stored in the STA matches GAS information stored in the AP.
